(19) United States
(12) Patent Application Publication
(10) Pub. No.: US 2015/0140957 A1
(43) Pub. Date: May 21, 2015

(54) PREPAID PHONE CARD CHARGING

(71) Applicant: DATA GUARD SOLUTIONS, INC., Oak Forest, IL (US)

(72) Inventors: Rafiq Kiswani, Orland Park, IL (US); Sufyan Almajali, Tinley Park, IL (US)

(73) Assignee: DATA GUARD SOLUTIONS, INC., Oak Forest, IL (US)

(21) Appl. No.: 14/085,120

(22) Filed: Nov. 20, 2013

(51) Int. Cl. H04M 17/00; H04W 4/24

(52) U.S. Cl. CPC H04M 17/301; H04W 4/24
USPC 455/406

(57) ABSTRACT

A prepaid card is credited to an account associated with a cellular device by receiving a prepaid card identifier from a user through an input device of the cellular device and saving the prepaid card identifier in a memory of the cellular device. A service provider for the cellular device is identified based on information stored on a subscriber identification module of the cellular device. A service provider specific procedure for crediting the prepaid card to the account is retrieved from a procedure database stored in the memory of the cellular device based on the identified service provider and the retrieved procedure is executed via a processor of the cellular device to send the prepaid card identifier to the identified service provider to credit the prepaid card to the account.

### FIELD OF THE DISCLOSURE

This disclosure relates generally to charging prepaid cards to accounts associated with cellular devices and, more particularly, to computerized methods for automatically crediting prepaid cards to an account associated with a cellular device with minimal user input.

### SUMMARY

In one example, a prepaid card can be credited to an account associated with a cellular device by receiving a prepaid card identifier from a user through an input device of the cellular device and saving the prepaid card identifier in a memory of the cellular device. A service provider for the cellular device is identified based on information stored on a subscriber identification module of the cellular device. A service provider specific procedure for crediting the prepaid card to the account is retrieved from a procedure database stored in the memory of the cellular device based on the identified service provider and the retrieved procedure is executed via a processor of the cellular device to send the prepaid card identifier to the identified service provider to credit the prepaid card to the account.

In further accordance with the foregoing example, a method for crediting a prepaid card to an account associated with a cellular device may further include, in any combination, any one or more of the following preferred forms.

In one preferred form, the prepaid card identifier is received as a text input and the text input is saved in the memory of the cellular device.

In another preferred form, the prepaid card identifier is received as an audio input, the step of receiving the prepaid card identifier further comprises converting the audio input into text using a voice recognition module, and the converted text is saved in the memory of the cellular device.

In another preferred form, the prepaid card identifier is received as an image, the step of receiving the prepaid card identifier further comprises converting the image into text using an image conversion module, and the converted text is saved in the memory of the cellular device.

In another preferred form, the image contains a barcode and the image conversion module is a barcode recognition module.

In another preferred form, the image contains a plurality of alpha-numeric characters and the image conversion module is a first optical character recognition module.

In another preferred form, the step of receiving the prepaid card identifier further comprises: converting the image into text using a second optical character recognition module, different from the first optical character recognition module; comparing the converted text from the first character recognition module with the converted text from the second character recognition module; saving the converted text from the first character recognition module in the memory of the cellular device if the converted text from the first character recognition module matches the converted text from the second character recognition module; and requesting additional information from the user if the converted text from the first character recognition module does not match the converted text from the second character recognition module.

In another preferred form, the step of identifying a service provider for the cellular device comprises: determining that the cellular device has multiple subscriber identification modules; identifying the service provider associated with each subscriber identification module based on information stored on each of the subscriber identification modules; and receiving from the user a selection of one of the service providers identified from the multiple subscriber identification modules to use as the identified service provider.

In another preferred form, the method further comprises the steps of receiving a procedure database update and saving the procedure database update in the memory of the cellular device.

In another preferred form, the procedure database update is limited to one of the procedure required for the identified service provider and the procedure required for a particular geographic location.

In another preferred form, the method further comprises the step of determining a location of the cellular device through a global positioning system of the cellular device.

In another preferred form, the service provider specific procedure is retrieved based on the identified service provider and the location of the cellular device.

In another preferred form, the method further comprises the steps of requesting additional required information from the user, receiving the additional information from the user, saving the additional information in the memory of the cellular device, and using the additional required information to execute the retrieved procedure.

In another preferred form, the method further comprises the steps of: receiving a request for an additional service provider service from a user through the input device; retrieving a service provider specific procedure for performing the additional service provider service from the procedure database based on the identified service provider; and executing the retrieved procedure via the processor.

In another preferred form, the method further comprises the steps of: accessing a remote master server over a network via a network interface of the cellular device; and sending a communication to the master server via the network interface, the communication comprising at least one of a request for information that is stored in a memory of the master server or an instruction to update information that is stored in the memory of the master server.

In another example, a tangible, non-transitory computer readable media has computer-executable instructions encoded thereon that, in response to execution by a processor, cause the processor to perform operations for crediting a prepaid card to an account associated with a cellular device. The operations include receiving a prepaid card identifier from a user through an input device of the cellular device and saving the prepaid card identifier in a memory of the cellular device; identifying a service provider for the cellular device based on information stored on a subscriber identification module of the cellular device; retrieving a service provider specific procedure for crediting the prepaid card to the account from a procedure database based on the identified service provider; and executing the retrieved procedure to send the prepaid card identifier to the identified service provider to credit the prepaid card to the account.

In further accordance with the foregoing example, a tangible, non-transitory computer readable media may further include, in any combination, any one or more of the following preferred forms.

In one preferred form, the prepaid card identifier is received as a text input and the operation of saving the prepaid card identifier comprises saving the text input in the memory of the cellular device.

In another preferred form, the prepaid card identifier is received as an audio input, the instructions, when executed by the processor, cause the processor to convert the audio input into text using a voice recognition module, and the operation of saving the prepaid card identifier comprises saving the converted text in the memory of the cellular device.

In another preferred form, the prepaid card identifier is received as an image, the instructions, when executed by the processor, cause the processor to convert the image into text using an image conversion module, and the operation of saving the prepaid card identifier comprises saving the converted text in the memory of the cellular device.

In another preferred form, the image contains a barcode and the image conversion module is a barcode recognition module.

In another preferred form, the image contains a plurality of alpha-numeric characters and the image conversion module is a first optical character recognition module.

In another preferred form, the instructions, when executed by the processor, cause the processor to perform operations comprising: converting the image into text using a second optical character recognition module, different from the first optical character recognition module; comparing the converted text from the first character recognition module with the converted text from the second character recognition module; saving the converted text from the first character recognition module in the memory of the cellular device if the converted text from the first character recognition module matches the converted text from the second character recognition module; and requesting additional information from the user if the converted text from the first character recognition module does not match the converted text from the second character recognition module.

In another preferred form, the instructions, when executed by the processor, cause the processor to perform operations comprising: determining if the cellular device has multiple subscriber identification modules; and identifying the service provider associated with each subscriber identification module based on information stored on each of the subscriber identification modules and receiving from the user a selection of one of the service providers identified from the multiple subscriber identification modules to use as the identified service provider if determined that the cellular device has multiple subscriber identification modules.

In another preferred form, the instructions, when executed by the processor, cause the processor to perform operations comprising receiving a procedure database update and saving the procedure database update in the memory of the cellular device.

In another preferred form, the procedure database update is limited to one of the procedure required for the identified service provider and the procedure required for a particular geographic location.

In another preferred form, the instructions, when executed by the processor, cause the processor to perform operations comprising determining a location of the cellular device through a global positioning system of the cellular device.

In another preferred form, the service provider specific procedure is retrieved based on the identified service provider and the location of the cellular device.

In another preferred form, the instructions, when executed by the processor, cause the processor to perform operations comprising: requesting additional required information from the user; receiving the additional information from the user; saving the additional information in the memory of the cellular device; and using the additional required information to execute the retrieved procedure.

In another preferred form, the instructions, when executed by the processor, cause the processor to perform operations comprising: receiving a request for an additional service provider service from a user through the input device; retrieving a service provider specific procedure for performing the additional service provider service from the procedure database based on the identified service provider; and executing the retrieved procedure.

In another preferred form, the instructions, when executed by the processor, cause the processor to perform operations comprising: accessing a remote master server over a network via a network interface of the cellular device; and sending a communication to the master server via the network interface, the communication comprising at least one of a request for information that is stored in a memory of the master server or an instruction to update information that is stored in the memory of the master server.

### BRIEF DESCRIPTION OF THE DRAWINGS

FIG. 1 is an example of a system that can be used for crediting a prepaid card to an account associated with a cellular device;

FIG. 2 is a schematic representation of an example of a cellular device of FIG. 1;

FIG. 3 is a schematic representation of an example computing device of FIG. 1;

FIG. 4 is a schematic representation of an example master server of FIG. 1;

FIG. 5 is a flowchart of an example method of crediting a prepaid card to an account associated with a cellular device using the system of FIG. 1;

FIG. 6 is a flowchart of an example method of obtaining service provider services using the system of FIG. 1; and

FIG. 7 is a flowchart of an example method of obtaining system services using the system of FIG. 1.

### DETAILED DESCRIPTION

Currently, when a user wishes to use a prepaid card, such as a prepaid phone card, for a cellular device the user is required to research and determine the steps required by their particular service provider to credit the prepaid card to their cellular account, manually enter the often time long alpha-numeric card identifier into their cellular device, and follow the exact steps required by the particular service provider. The current process can be lengthy and is prone to mistakes in the performance of the steps required by the service provider or in the input of the card identifier. The systems and methods described herein provide an automated, computerized way for a user to activate a prepaid card or credit the amount of the prepaid card to an account that is associated with a cellular device, which can be simpler, faster, and more accurate than manual entry and charging by the user.

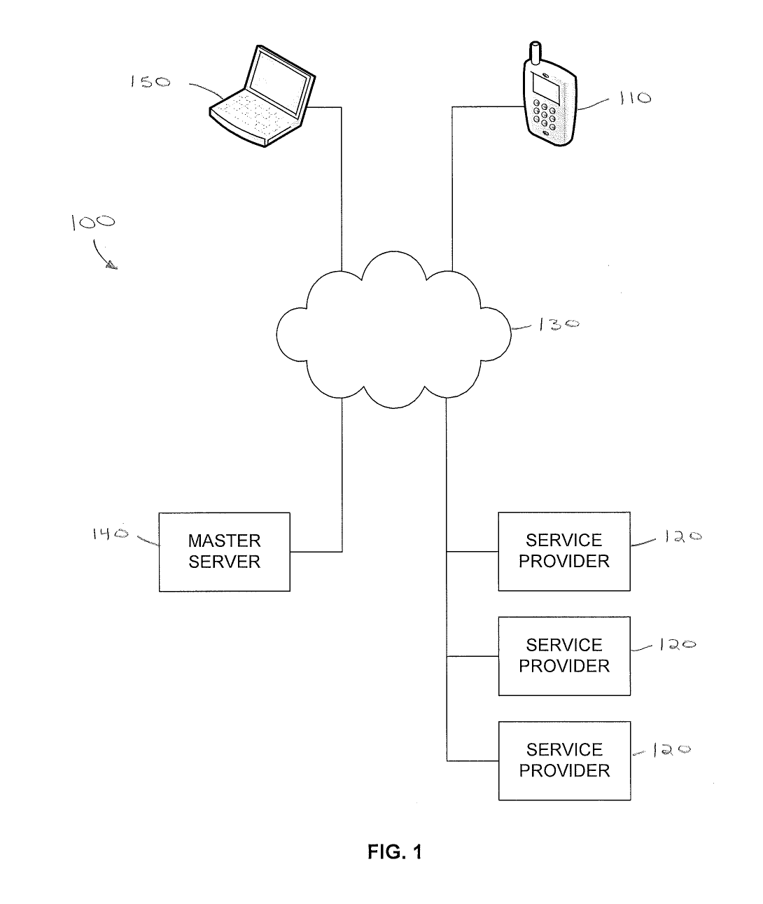

Referring to FIG. 1, an example system 100 is shown in which a cellular device 110 communicates with one or more service provider systems 120 through one or more networks 130. In the example shown, cellular device 110 is a smart phone or other type of cell phone, but cellular device 110 could be any type of cellular device having network communication capabilities (e.g., having a subscriber identification module (SIM card)) and capable of storing and executing computer-executable instructions, such as a tablet computer. Cellular device 110 will have a designated phone number that is associated with an account with one or more service providers to provide communications services for cellular device 110. This account is used to identify the device and to track the usage of the device for charging the user accordingly.

Service provider systems 120 are the computerized systems operated by cellular and network providers, such as AT&T®, Verizon®, Sprint®, etc., and will be particular to the specific service provider. Typically, service providers will store, maintain, and manage the accounts of their subscribers through service provider systems 120.

Network(s) 130 will typically be a cellular, short message service (SMS), or Wi-Fi type network. However, network(s) 130 can be any other type of network that is capable of providing communications for a cellular device. In addition, depending on the cellular device 110 being used and the particular service provider system 120, communications could occur through a variety of network(s) 130. For example, many smart phones will use a Wi-Fi network for data communications when one is available, but will use a cellular network for the same data communications if not in range of a known Wi-Fi network.

In the example shown, cellular device 110 can also communicate with master server 140 through network(s) 130. As discussed in more detail below, master server 140 can be used to store and provide software and/or apps to cellular device 110 over network(s) 130, to store a master database of service provider information and provide information from the master database to cellular device 110, to store a database of user accounts and user data, and to store and provide access to various usage data. Master server 140 is shown as a single server in the example shown, however, it will be understood that master server 140 could include multiple servers if desired based on a particular system and system load. For example, master server 140 could include a web server connected to network(s) 130 to provide web pages and receive information from a user and an application server connected to the web server to store information and perform various application processes.

Optionally, master server 140 can also communicate with computing device 150 through network(s) 130. In the example shown, computing device 150 is a standard computer, such as a laptop, desktop, tablet computer, etc., but could be any type of computing device having network communication capabilities and that is capable of running a web browser and accessing a website over the Internet.

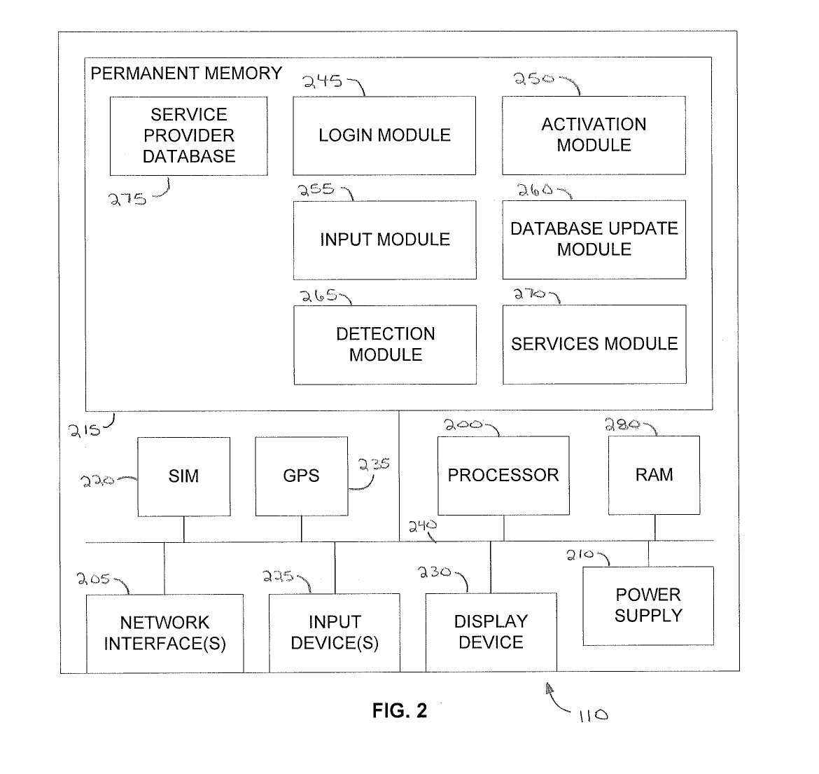

Referring to FIG. 2, a schematic representation of an example cellular device 110 is shown. As discussed above, cellular device 110 can be a smart phone, a cell phone, or any other type of cellular device having network communication capabilities (e.g., having a SIM card) and that is capable of storing and executing computer-executable instructions, such as a tablet computer. Cellular device 110 will generally include a processor 200, a network interface 205, a power supply 210, non-transitory or permanent memory 215, transitory or temporary memory 280, a SIM card 220, at least one input device 225, a display device 230, and a global positioning system (GPS) receiver 235, all interconnected by a power bus 240. Network interface 205 could be any type of interface that will allow cellular device 110 to communicate over a network, such as a cellular, SMS, or Wi-Fi network, and cellular device 110 could include more than one network interface 205, to allow cellular device 110 to communicate over various types of networks. Similarly, cellular device 110 could have more than one SIM card 220 to allow cellular device 110 to be used with different service providers. Input device 225 could be any typical input device, such as a mechanical keyboard, a touch screen keyboard, a camera, or a microphone, and cellular device 110 may have any number and combination of input device(s) 225.

Memory 215 of cellular device 110 can be a non-transitory computer readable media, such as a hard drive, and can store a variety of software modules, which can be downloaded from master server 140, as described in more detail below. In the example shown, memory 215 includes a login module 245, an activation module 250, an input module 255, a database update module 260, a detection module 265, and a services module 270. These modules each include computer-executable instructions that, in response to execution by processor 200, cause processor 200 to perform the operations described in more detail below. For example, login module 245 can include computer-executable instructions that will allow a user to create or login to an account on cellular device 110 or on master server 140 from cellular device 110. Activation module 250 can include computer-executable instructions to determine the steps required by a particular service provider to credit the prepaid card to an account on a particular service provider system 120 and to execute the required steps. Input module 255 can include computer-executable instructions to receive a prepaid card identifier input from a user and convert the input into a format that can be used by activation module 250. For example, input module 225 could include a voice recognition module, and/or an image conversion module, which could also include a barcode recognition module, and/or one or more optical character recognition modules. Database update module 260 can include computer-executable instructions to periodically or manually update a service provider database 275 or portions of service provider database 275. Detection module 265 can include computer-executable instructions to automatically detect a service provider for a particular cellular device 110 from information stored on SIM card 220 and/or to determine the current geographic location of cellular device 110 through GPS receiver 235. Services module 270 can include computer executable instructions to determine the steps required by a particular service provider for additional services offered, such as checking the balance remaining, checking the quantity of voice minutes used, checking the quantity of data used, etc., and to execute these required steps and/or to request system services from master server 140. While the various functions described herein are shown as being performed by individual software modules, it will be understood that the functions could be performed by any number and/or combination of modules or by a single software module. Memory 215 can also include a service provider database 275, which stores information regarding the steps required by various service providers to credit a prepaid card to a service provider account and to perform various other services offer by a particular service provider.

Memory 280 of cellular device 110 can be a transitory type memory, such as RAM, and is typically used to store portions of software modules for execution by processor 200 and for the temporary storage of certain data. For example, memory 280 could be used for the temporary storage of an audio or image input during the processing/conversion of the audio or image input, as discussed in more detail below. In addition, memory 280 could be used for the temporary storage of information received from master service provider database 450 and then permanently stored in memory 215.

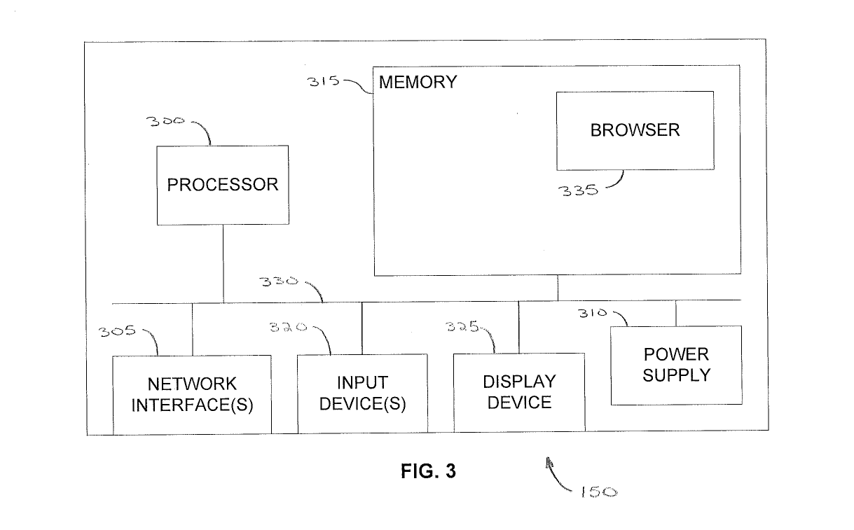

Referring to FIG. 3, a schematic representation of an example computing device 150 is shown. As discussed above, computing device 150 can be a standard computer, such as a laptop, desktop, tablet computer, etc., or any type of computing device having network communication capabilities and that is capable of running a web browser and accessing a website over a network, such as the Internet. Computing device 150 will generally include a processor 300, a network interface 305, a power supply 310, memory 315, at least one input device 320, and a display device 325, all interconnected by a power bus 330. Network interface 305 could be any type of interface that will allow computing device 150 to communicate over a network, such as a local area network (LAN), wide area network (WAN), cellular network, or Wi-Fi network, and computing device 150 could include more than one network interface 305, to allow computing device 150 to communicate over various types of networks. Input device 320 could be any typical input device, such as a keyboard, a touch screen, a mouse, a touchpad, or a microphone, and computing device 150 may have any number and combination of input device(s) 320.

Memory 315 of computing device 150 can store a variety of software and databases, which could include a browser program 335, which can be any browser or other software that will allow a user to access master server 140 through the Internet or other network, such as Chrome®, Firefox®, Internet Explorer®, Opera®, Safari®, or others.

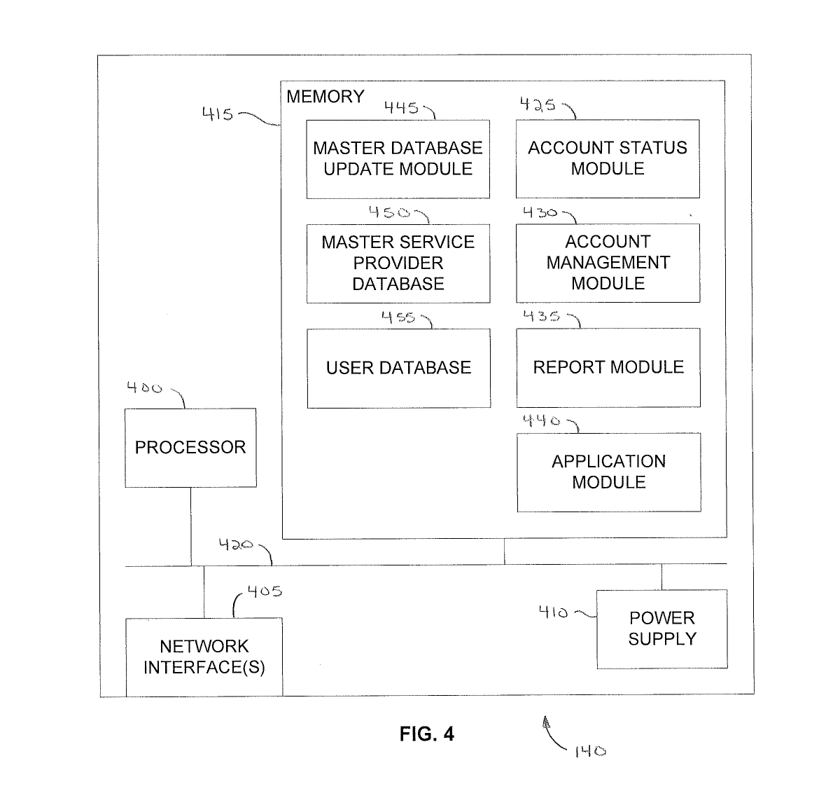

Referring to FIG. 4, a schematic representation of an example master server 140 is shown. Master server 140 will generally include a processor 400, a network interface 405, a power supply 410, and memory 415, all interconnected by a power bus 420. Network interface 405 could be any type of interface that will allow master server 140 to communicate over a network, such as a local area network (LAN), wide area network (WAN), cellular network, or Wi-Fi network, and master server 140 could include more than one network interface 405, to allow master server 140 to communicate over various types of networks.

Memory 415 of master server 140 can store a variety of software modules, such as an account status module 425, an account management module 430, a report module 435, an application module 440, and a master database update module 445. These modules each include computer-executable instructions that, in response to execution by processor 400, cause processor 400 to perform the operations described in more detail below. For example, account status module 425 can include computer-executable instructions that will allow a user to check the status of the user's account, such as cards loaded, minutes used, data used, etc. Account management module 430 can include computer-executable instructions that will allow a user to create a new user account or to update information in a current user account. Report module 435 can include computer-executable instructions that will allow a user to run reports on the users account, such as a monthly charging report. Application module 440 can include computer-executable instructions that will allow a user to download application software from master server 140. Alternatively, rather than providing application software from master server 140, the application software could be provided and downloaded from an application store for a specific platform (e.g. Android®, Apple®, Windows®, etc.) and application module 440 would not be necessary. Master database update module 445 can include computer-executable instructions that will allow a user or a cellular device to download updates to the master service provider database 450. While the various functions described herein are shown as being performed by individual software modules, it will be understood that the functions could be performed by any number and/or combination of modules or by a single software module. Memory 415 can also include a master service provider database 450 and a user database 455. Master service provider database 450 can store information regarding the steps required by various service providers to credit a prepaid card to a service provider account and to perform various other services offer by a particular service provider. User database 455 can store information regarding the accounts setup by the users of system 100.

Using system 100 described above, a user can credit a prepaid phone card to their account, obtain service provider services, and obtain system services much faster and more accurately than previously known manual entry operations.

In one example, a user could first download and install an application on cellular device 110. The application could be downloaded from master server 140, could be obtained from an application store of a targeted platform (e.g. Android®, Apple®, Windows®, etc.), or could be obtained in other ways. The application installed on cellular device 110 can include login module 245, activation module 250, input module 255, database update module 260, detection module 265, services module 270, and service provider database 275. When the application is installed, service provider database 275 could be a full database containing procedures for all services providers, geographic locations, etc., or could be an empty database, which can be filled with data at a later time, such as when a user sets up the application or when a user proceeds to credit a prepaid card. In addition, service provider database 275 could contain procedures related to a variety of services providers or could be limited to a single service provider (or multiple particular service providers if cellular device 110 is configured to use multiple service providers) associated with cellular device 110. Similarly, service provider database 275 could also contain procedures related to all geographic locations or could be limited to particular geographic locations selected by the user or the current geographic location of cellular device 110.

In one specific example, when the application is launched on cellular device 110, login module 245 could optionally request that the user login to an existing account or create a new account. Login module 245 could display a login screen through display device 230 that asks the user for a user name and password, or some other identifying information, and compare the user name and password entered by the user to a list of authorized user names and passwords to verify that the user is authorized to use the application and to retrieve information particular to that user. The login screen can also provide options to create a new account and/or obtain other services, such as retrieving or resetting a forgotten password. Login could be required before the user can use any functions of the application or could be required only for the use of specific features, such as obtaining service provider services or obtaining system services.

When the application is launched (if no login is required) or when a user creates a new account or logs into an existing account (if required) the application could download or update service provider database 275.

If service provider database 275 was empty when the application was downloaded and installed, database update module 260 could connect to master server 140 over network(s) 130 through network interface(s) 205 and request a copy of the data from master service provider database 450, which could then be temporarily saved in temporary memory 280 and/or saved in service provider database 275 in permanent memory 215. As discussed above, database update module 260 could request a full copy of all of the data in master service provider database 450 or could request only a portion of the data in master service provider database 450. For example, the application can be configured such that service provider database 275 only contains data related to the specific service provider associated with cellular device 110 and/or only data specific to the current geographic location of cellular device 110. If only limited information is required, database update module 260 can communicate with detection module 265 to determine the service provider for and current geographic location of cellular device 110. Detection module 265 can then determine the service provider associated with cellular device 110 from information stored on SIM card 220, determine the current geographic location of cellular device 110 with information from GPS receiver 235, and return this information to database update module 260. Database update module 260 can then use the service provider and location information from detection module 265 to request only service provider and location specific data from master server 140, rather than all of the data in master service provider database 450.

If there is already data in service provider database 275 when the application is launched, database update module 260 could connect to master server 140 over network(s) 130 through network interface(s) 205 to determine if there have been any updates to the relevant data in master service provider database 450. Master server 140 could then run a query to determine if there have been any updates since the last update returned to cellular device 110 and return any recent update results to database update module 260, which could temporarily store the updated data in memory 280 and/or save the updated data in service provider database 275 in memory 215.

Once the user has downloaded and installed the application and has logged into their account, if required, the user can be provided with a variety of options, such as crediting a new prepaid card, checking the balance of previously credited prepaid cards (a service provider service), reviewing prior crediting and charging history (a system service), and viewing/updating application settings (e.g., user account settings, service provider information, security settings, additional required information, etc., which are system services).

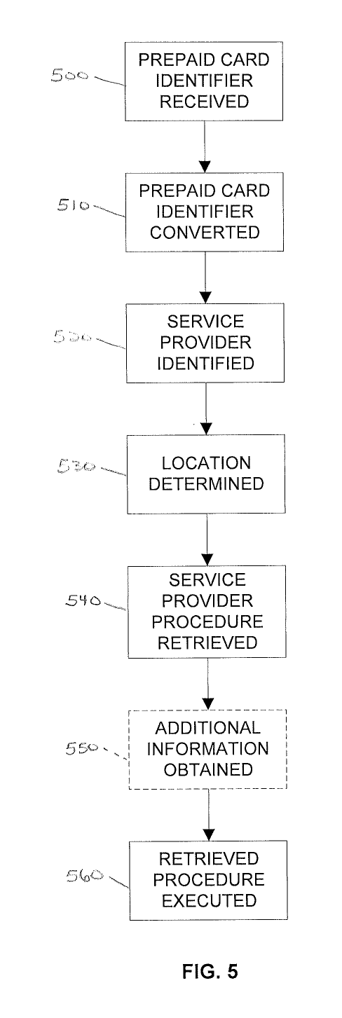

Referring to FIG. 5, one example of a method for crediting a prepaid card to an account associated with cellular device 110 using system 100 is shown. At Step 500, the prepaid card identifier is entered. When a user obtains a prepaid card they are typically required to scratch an area on the card to reveal a prepaid card identifier that identifies that specific card. The prepaid card identifier usually consist of a series of numeric or alpha-numeric characters, but could also be a barcode, a QR code (3-dimensional barcode), or any other type of identifier. The user can enter the prepaid card identifier using a variety of methods. For example, the user could use a text entry type input device 225, such as a keyboard or a touch screen keyboard, to enter the prepaid card identifier as a text input, which input module 255 could save in memory 215 and/or in temporary memory 280 and the process would continue with Step 520. In addition, the user could use an audio type input device 225, such as a microphone, to enter the prepaid card identifier as an audio input, which input module 255 could save in memory 215 and/or in temporary memory 280 and the process would continue with Step 510. Preferably, the user will use an imaging type input device, such as a camera, to capture an image of the prepaid card identifier. Input module 255 could open a camera application on cellular device 110 and display a rectangle or other indicia that the user can use to surround the prepaid card identifier and capture the image. Once the image is captured, input module 255 could save the captured image in memory 215 and/or in temporary memory 280 and the process will continue with Step 510.

At Step 510, the prepaid card identifier is converted into a format, typically text, that can be used by activation module 250 to credit the prepaid card. If the prepaid card identifier was entered as a text input, conversion of the prepaid card identifier may not be needed and this step may not be required. If the prepaid card identifier was entered as an audio input, input module 255 can use a voice recognition module, program, or subroutine (e.g., SIRI, IRIS, or other standard voice recognition programs) to convert the audio input into text and save the converted text in memory 215 and/or in temporary memory 280 for use by activation module 250. If the prepaid card identifier was captured as an image, input module 255 can use a standard image conversion module, program, or subroutine to convert the image into text and save the converted text in memory 215 and/or in temporary memory 280 for use by activation module 250. For example, if the image captured contains a barcode, input module 255 could use a barcode recognition module, program, or subroutine to convert the captured image into text. If the captured image contains a plurality of alpha-numeric characters, input module 255 could use an optical character recognition module, program, or subroutine to convert the captured image into text.

Preferably, when the captured image contains a plurality of alpha-numeric characters, input module 255 will also use a second optical character recognition module, program, or subroutine, which is different from the initial optical character recognition module, to perform a second conversion of the captured image into text. Input module 255 would then compare the converted text from the two optical character recognition modules to determine if the converted text from both optical character recognition modules match. If the converted text from both optical character recognition modules matches, input module 255 can save the converted text from either optical character recognition module into memory 215 and/or into temporary memory 280 for use by activation module 250. If the converted text from both optical character recognition modules does not match, input module 255 could alert the user of the discrepancy and request additional information from the user to correct the discrepancy. Use of multiple optical character recognition modules and comparison of the conversion results from these modules can increase the accuracy of the prepaid card identifier entry over using only a single optical character recognition module, which could be more prone to mistakes. For example, if there are unclear numbers or areas where the numbers are not completely visible because they were not completely scratched off, this process can warn the user about the unclear portions and ask for clarification.

At Step 520, the service provider associated with cellular device 110 is identified. In the example shown, identification of the service provider is performed during the process of crediting the prepaid card. However, identification of the service provider could also be done during the initial setup of the application and the identified service provider saved in memory 215 for later use, rather than identifying the service provider each time a prepaid card is being credited, in which case this step would not be required. Rather, activation module 250 would use the identified service provider previously stored in memory 215.

Preferably, when identification of the service provider is performed during the card crediting process, activation module 250 will request the identification of the service provider associated with cellular device 110 from detection module 265. Detection module 265 will then retrieve the required service provider identification and related information from information stored on SIM card 220 of cellular device 110 and provide the identified service provider and related information back to activation module 250. In this way, identification of the service provider is automated and does not require any action or input from the user.

In some instances, cellular device 110 may have multiple SIM cards 220, each associated with a different service provider. In these instances, detection module 265 will detect that there are multiple SIM cards 220, retrieve the service provider identification and related information from each SIM card 220, and return this information to activation module 250. If identification of multiple service providers is received, activation module 250 can alert the user and prompt the user to select which service provider is to be used for the prepaid card being charged.

Alternatively, the service provider associated with the cellular device could be requested from and manually input by the user. Activation module 250 could request the identification of the service provider from the user and provide the user with a drop down menu or other list that contains the identification of the services providers contained in service provider database 275 and/or master service provider database 450. The user could then select the service provider using input device(s) 225 and activation module 250 would save the service provider input by the user in memory 215.

If there are specific service providers that require additional information or require that additional steps be taken based on the geographic location of cellular device 110, at Step 530, the current geographic location of cellular device 110 can be determined. If the current geographic location of cellular device 110 is not needed, this step can be skipped. In the example shown, determining the current geographic location is performed during the process of crediting the prepaid card. However, determining the current geographic location could also be done when the application is launched, rather than determining the geographic location each time a prepaid card is being credited, in which case this step would not be required. Rather, activation module 250 would use the geographic location determined when the application was launched.

Preferably, when determination of the current geographic location is performed during the card crediting process, activation module 250 will request the current location of cellular device 110 from detection module 265. Detection module 265 will then determine the current location using GPS receiver 235 of cellular device 110 and provide the current location of cellular device 110 back to activation module 250. In this way, determination of the current geographic location of cellular device 110 is automated and does not require any action or input from the user.

Alternatively, the current location could be requested from and manually input by the user. Activation module 250 could request the current location from the user and provide the user with a drop down menu or other list that contains a list of countries, cities, etc. The user could then select the current location using input device(s) 225 and activation module 250 would save the current location input by the user in memory 215 and/or in temporary memory 280.

At Step 540, the service provider procedure for the identified service provider is retrieved from service provider database 275. Each service provider will have different procedures for crediting a prepaid card based on various factors such as the card type, country, etc. The number of steps, sequence of steps, and actions required in each step for each service provider are stored in service provider database 275. In the example shown, activation module 250 can use the identified service provider from Step 520 and query service provider database 275 for the specific procedures required by the identified service provider to credit the prepaid card. In addition, if a current location was determined in Step 530, activation module 250 can include that information in the query and retrieve specific procedures based on the current geographic location. The storage of the service provider procedures and automatic retrieval of the procedures from service provider database 275 relieves the user from having to look up or memorize the procedures for their specific service provider.

If a particular service provider is not included in service provider database 275, activation module 250 could allow a user to create a new service provider and set up the steps required for the new service provider. This information can then be stored in service provider database 275 and used next time a prepaid card is credited. This new service provider information can also be sent back to master server 140 and saved in master service provider database 450 for future use.

As discussed above, service provider database 275 could be installed and populated with data from master service provider database 450 when the application is installed or when a user sets up the application. The data in service provider database 450 could be a full copy of master service provider database 450 or only contain information for a specific service provider, specific geographic locations, etc. If service provider database 275 is populated with data and updated, activation module 250 will proceed with the service provider query described above.

If service provider database 275 has not been updated, system 100 can provide automatic service provider database 275 updates, or a user can request a manual update. Database update module 260 can update service provider database 275 prior to activation module 250 querying service provider database 275. Database update module 260 can connect to master server 140 over network(s) 130 through network interface(s) 205 to determine if there have been any updates to the relevant data in master service provider database 450. Master server 140 could then run a query to determine if there have been any updates since the last update returned to cellular device 110 and return any update results to database update module 260, which could save the updated data in service provider database 275.

If service provider database 275 is empty, database update module 260 can connect to master server 140 over network(s) 130 through network interface(s) 205 and request a copy of the data from master service provider database 450, which could then be saved in service provider database 275. As discussed above, database update module 260 could request a full copy of all of the data in master service provider database 450 or could request only a portion of the data in master service provider database 450.

If the service provider procedure retrieved from service provider database 275 indicates that additional information is required (e.g., certain service provider procedures in certain countries may require additional information such as a National ID for security reasons), the process continues with Step 550. If additional information is not required, the process continues with Step 560.

If additional information is required for a specific service provider and/or a particular geographic location, at Step 550 the additional information is obtained. If no additional information is required for a particular service provider or a particular geographic location, this step can be skipped. Activation module 250 can request the additional information from a user by providing an input screen through display device 230. The user can then supply the additional information requested using input device 225 and activation module 250 can save the additional information supplied by the user in memory 215 and/or in temporary memory 280.

At Step 560, the retrieved service provider procedure is executed and the prepaid card identifier is sent to the identified service provider to credit the prepaid card to the account associated with cellular device 110. The steps taken by activation module 250 to send the prepaid card identifier to the identified service provider and to credit the prepaid card will vary depending on the particular service provider and the procedures required by that service provider. However, in most instances activation module 250 will retrieve the text of the prepaid card identifier from memory 215 or memory 280 and prepare a message containing the prepaid card identifier and any other required text. The message will then be sent by activation module 250 to the identified service provider system 120 through network(s) 130, usually in SMS format. Additional information could also be included in the message and/or additional steps can be taken if required by the identified service provider.

In addition to providing procedures for crediting a prepaid card to an account, many service providers will also offer other options to users for additional service provider services, such as checking balances of previously loaded prepaid cards, checking voice minutes used, checking data used, etc. To use these service provider services, many service providers require users to text a message to a certain number with certain text and codes. Like the process for crediting a prepaid card, system 100 and also automate and simplify the use of such services.

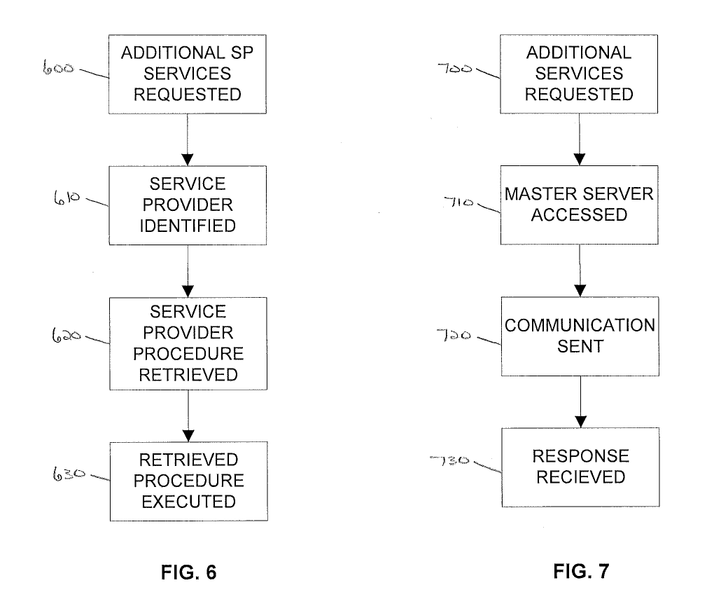

Referring to FIG. 6, one example of a method for obtaining service provider services is shown. At Step 600, an additional service provider service is requested by the user. As discussed above, the application can provide the user with a variety of options, for example requesting an additional service provider service, such as checking the balance of previously credited prepaid cards. To request an additional service provider service, the user would use input device 225 of cellular device 110 to indicate that an additional service provider service is being requested and, if there are multiple service provider services available, select the desired additional service provider service. This information is then received by services module 270, which can automatically execute the steps described below to obtain the additional service provider service.

At Step 610, the service provider associated with cellular device 110 is identified. In the example shown, identification of the service provider is performed during the process of providing additional service provider services. However, as discussed above, identification of the service provider could also be done during the initial setup of the application or during the prepaid card crediting process and the identified service provider can be saved for later use, rather than identifying the service provider each time a service provider service is requested, in which case this step would not be required. Rather, services module 270 would use the identified service provider previously stored in memory 215.

If identification of the service provider is performed during the service provider services process, services module 270 will request the identification of the service provider associated with cellular device 110 from detection module 265. Detection module 265 will then retrieve the required service provider identification and information from information stored on SIM card 220 of cellular device 110 and provide the identified service provider back to services module 270. In this way, identification of the service provider is automated and does not require any action or input from the user.

As described above, if cellular device 110 has multiple SIM cards 220, each associated with a different service provider, detection module 265 will detect that there are multiple SIM cards 220, retrieve the service provider identification and information from each SIM card 220, and return this information to services module 270. Services module 270 can then alert the user and prompt the user to select which service provider is to be used for the service provider services being requested.

Alternatively, the service provider associated with the cellular device could be requested from and manually input by the user, as discussed above.

At Step 620, the service provider procedure for performing the additional services is retrieved from service provider database 275. Each service provider will offer different additional services and have different procedures for providing the additional services offered. The number of steps, sequence of steps, and actions required in each step for each service provider are stored in service provider database 275. In the example shown, services module 270 can use the identified service provider from Step 610 and query service provider database 275 for the specific procedures required by the identified service provider to perform the requested additional service. The storage of the service provider procedures and automatic retrieval of the procedures from service provider database 275 relieves the user from having to look up or memorize the procedures for their specific service provider.

As discussed above, service provider database 275 could be installed and populated with data from master service provider database 450 when the application is installed or when a user sets up the application. The data in service provider database 450 could be a full copy of master service provider database 450 or only contain information for a specific service provider, specific geographic locations, etc. If service provider database 275 is populated with data and updated, services module 270 will proceed with the service provider query discussed above.

In addition, system 100 can provide automatic service provider database 275 updates, a user can request a manual update, or service provider database 275 can request data from master service provider database 450 if service provider database 275 is empty, to allow the application to function worldwide, as described above.

At Step 630, the retrieved service provider procedure for providing the additional service is executed. The steps taken by services module 270 will vary depending on the particular service provider and the procedures required by that service provider. However, in most instances services module 270 will prepare a message containing predetermined text and send the message to the identified service provider system 120 through network 130, usually in SMS format. Service provider system 120 will then provide the requested additional service and return the requested information back to the user.

System 100 can also provide additional services, other than those provided by the service providers. For example, system 100 can provide a user with an on-line portal to allow the user to view charging history, manager the user's user name and/or password, manage security options, run reports, etc.

Referring to FIG. 7, one example of a method for obtaining additional system services is shown. At Step 700, an additional system service is requested by the user. As discussed above, the application can provide the user with a variety of options, for example requesting system provided services, such as reviewing prior crediting and charging history, viewing/updating application settings, etc. To request an additional system service, the user would use input device 225 of cellular device 110 to indicate that an additional system service is being requested and, if there are multiple system services available, select the desired additional system service.

Alternatively, a user can request additional services using computing device 150, rather than cellular device 110. The user can use browser 335 on computing device 150 to connect to master server 140 over network(s) 130 through network interface(s) 305 of computing device 150. Using web pages accessed on master server 140, the user can use input device 320 to indicate that an additional system service is being requested and, if there are multiple system services available select the desired additional system service.

At Step 710, master server 140 is accessed. Once services module 270 receives a request for an additional system service, master server 140 can be accessed over network(s) 130 through network interface(s) 205 of cellular device 110. Preferably, access to master server 140 is restricted and a user will be required to login into the application in order the access master server 140. To login to the application, login module 245 can provide the user with a login screen and require the user to enter identifying information, such as a user name and password, in order to access these services.

If the user is using computing device 150, the user will be provided a login page requiring the user to login to the system as described above. Once the user has provided the required information and the user's identity has been validated, the information on master server 140 associated with that user can be accessed.

At Step 720, a communication is sent from cellular device 110 to master server 140 requesting the additional system service. Depending on the additional system service requested, the communication could contain a request for information stored in memory 415 of master server 140, a request to update information stored in memory 415 of master server 140, etc. For example, if a user wanted to check the balance of a prepaid card previously credited, a communication could be sent from services module 270 of cellular device 110 to account status module 425 of master server 140 requesting this information. Account status module 425 could then retrieve this information from user database 455 and return the information requested to cellular device 110. Similarly, if a user wanted to update personal or other information associated with their account, a communication could be sent from services module 270 of cellular device 110 to account management module 430 of master server 140 requesting the information be updated. Account management module 430 could then save the updated information in user database 455 and, if desired, send a confirmation back to cellular device 110 that the information has been updated. Furthermore, if a user wanted to run a report related to the user account, a communication could be sent from services module 270 of cellular device 110 to report module 435 of master server 140 requesting the report. Report module 435 could then retrieve the information for the report from user database 455, organize the retrieve information into a report format, and return the report requested to cellular device 110.

If the user is using computing device 150, the user can make the same requests and the communications will be sent to the various modules of master server 140 through browser 335, rather than services module 270.

At Step 730, a response to the communication requesting the additional system service is received by cellular device 110 or computing device 150. As described above, this response could be requested information, a confirmation that account information has been updated, a requested report, etc., depending on the system service requested.

Preferably, system 100 will provide multiple security measures to secure user transactions and access, such as restricting users to certain phone numbers, secured portal access (https access), protection against most common website attacks (e.g., SQL Injection, XSS, etc.), restrict Admin access to certain IP Block, etc.

While particular embodiments of the present invention have been shown and described, it will be obvious to those skilled in the relevant arts that changes and modifications may be made without departing from the invention in its broader aspects. Therefore, the aim in the appended claims is to cover all such changes and modifications that fall within the true spirit and scope of the invention. The matter set forth in the foregoing description and accompanying drawings is offered by way of illustration only and not as a limitation. The actual scope of the invention is intended to be defined in the following claims when viewed in their proper perspective based on the prior art.

What is claimed is:

1. A computerized method for crediting a prepaid card to an account associated with a cellular device, comprising the steps of:
receiving a prepaid card identifier from a user through an input device of the cellular device and saving the prepaid card identifier in a memory of the cellular device;
identifying a service provider for the cellular device based on information stored on a subscriber identification module of the cellular device;
retrieving a service provider specific procedure for crediting the prepaid card to the account from a procedure database stored in the memory of the cellular device based on the identified service provider; and
executing the retrieved procedure via a processor of the cellular device to send the prepaid card identifier to the identified service provider to credit the prepaid card to the account.

2. The method of claim 1, wherein the prepaid card identifier is received as a text input and the text input is saved in the memory of the cellular device.

3. The method of claim 1, wherein the prepaid card identifier is received as an audio input, the step of receiving the prepaid card identifier further comprises converting the audio input into text using a voice recognition module, and the converted text is saved in the memory of the cellular device.

4. The method of claim 1, wherein the prepaid card identifier is received as an image, the step of receiving the prepaid card identifier further comprises converting the image into text using an image conversion module, and the converted text is saved in the memory of the cellular device.

5. The method of claim 4, wherein the image contains a barcode and the image conversion module is a barcode recognition module.

6. The method of claim 4, wherein the image contains a plurality of alpha-numeric characters and the image conversion module is a first optical character recognition module.

7. The method of claim 6, wherein the step of receiving the prepaid card identifier further comprises:
converting the image into text using a second optical character recognition module, different from the first optical character recognition module;
comparing the converted text from the first character recognition module with the converted text from the second character recognition module;
saving the converted text from the first character recognition module in the memory of the cellular device if the converted text from the first character recognition module matches the converted text from the second character recognition module; and
requesting additional information from the user if the converted text from the first character recognition module does not match the converted text from the second character recognition module.

8. The method of claim 1, wherein the step of identifying a service provider for the cellular device comprises:
determining that the cellular device has multiple subscriber identification modules;
identifying the service provider associated with each subscriber identification module based on information stored on each of the subscriber identification modules; and
receiving from the user a selection of one of the service providers identified from the multiple subscriber identification modules to use as the identified service provider.

9. The method of claim 1, further comprising the steps of receiving a procedure database update and saving the procedure database update in the memory of the cellular device.

10. The method of claim 9, wherein the procedure database update is limited to one of the procedure required for the identified service provider and the procedure required for a particular geographic location.

11. The method of claim 1, further comprising the step of determining a location of the cellular device through a global positioning system of the cellular device.

12. The method of claim 11, wherein the service provider specific procedure is retrieved based on the identified service provider and the location of the cellular device.

13. The method of claim 1, further comprising the steps of requesting additional required information from the user, receiving the additional information from the user, saving the additional information in the memory of the cellular device, and using the additional required information to execute the retrieved procedure.

14. The method of claim 1, further comprising the steps of:
receiving a request for an additional service provider service from a user through the input device;
retrieving a service provider specific procedure for performing the additional service provider service from the procedure database based on the identified service provider; and
executing the retrieved procedure via the processor.

15. The method of claim 1, further comprising the steps of:
accessing a remote master server over a network via a network interface of the cellular device; and
sending a communication to the master server via the network interface, the communication comprising at least one of a request for information that is stored in a memory of the master server or an instruction to update information that is stored in the memory of the master server.

16. A tangible, non-transitory computer readable media having computer-executable instructions encoded thereon that, in response to execution by a processor, cause the processor to perform operations for crediting a prepaid card to an account associated with a cellular device, the operations comprising:
receiving a prepaid card identifier from a user through an input device of the cellular device and saving the prepaid card identifier in a memory of the cellular device;
identifying a service provider for the cellular device based on information stored on a subscriber identification module of the cellular device;
retrieving a service provider specific procedure for crediting the prepaid card to the account from a procedure database based on the identified service provider; and
executing the retrieved procedure to send the prepaid card identifier to the identified service provider to credit the prepaid card to the account.

17. The computer readable media of claim 16, wherein the prepaid card identifier is received as a text input and the operation of saving the prepaid card identifier comprises saving the text input in the memory of the cellular device.

18. The computer readable media of claim 16, wherein the prepaid card identifier is received as an audio input, the instructions, when executed by the processor, cause the processor to convert the audio input into text using a voice recognition module, and the operation of saving the prepaid card identifier comprises saving the converted text in the memory of the cellular device.

19. The computer readable media of claim 16, wherein the prepaid card identifier is received as an image, the instructions, when executed by the processor, cause the processor to convert the image into text using an image conversion module, and the operation of saving the prepaid card identifier comprises saving the converted text in the memory of the cellular device.

20. The computer readable media of claim 19, wherein the image contains a barcode and the image conversion module is a barcode recognition module.

21. The computer readable media of claim 19, wherein the image contains a plurality of alpha-numeric characters and the image conversion module is a first optical character recognition module.

22. The computer readable media of claim 21, wherein the instructions, when executed by the processor, cause the processor to perform operations comprising:
converting the image into text using a second optical character recognition module, different from the first optical character recognition module;
comparing the converted text from the first character recognition module with the converted text from the second character recognition module;
saving the converted text from the first character recognition module in the memory of the cellular device if the converted text from the first character recognition module matches the converted text from the second character recognition module; and
requesting additional information from the user if the converted text from the first character recognition module does not match the converted text from the second character recognition module.

23. The computer readable media of claim 16, wherein the instructions, when executed by the processor, cause the processor to perform operations comprising:
determining if the cellular device has multiple subscriber identification modules; and
identifying the service provider associated with each subscriber identification module based on information stored on each of the subscriber identification modules and receiving from the user a selection of one of the service providers identified from the multiple subscriber identification modules to use as the identified service provider if determined that the cellular device has multiple subscriber identification modules.

24. The computer readable media of claim 16, wherein the instructions, when executed by the processor, cause the processor to perform operations comprising receiving a procedure database update and saving the procedure database update in the memory of the cellular device.

25. The computer readable media of claim 24, wherein the procedure database update is limited to one of the procedure required for the identified service provider and the procedure required for a particular geographic location.

26. The computer readable media of claim 16, wherein the instructions, when executed by the processor, cause the processor to perform operations comprising determining a location of the cellular device through a global positioning system of the cellular device.

27. The computer readable media of claim 26, wherein the service provider specific procedure is retrieved based on the identified service provider and the location of the cellular device.

28. The computer readable media of claim 16, wherein the instructions, when executed by the processor, cause the processor to perform operations comprising:
requesting additional required information from the user;
receiving the additional information from the user;
saving the additional information in the memory of the cellular device; and
using the additional required information to execute the retrieved procedure.

29. The computer readable media of claim 16, wherein the instructions, when executed by the processor, cause the processor to perform operations comprising:
receiving a request for an additional service provider service from a user through the input device;
retrieving a service provider specific procedure for performing the additional service provider service from the procedure database based on the identified service provider; and
executing the retrieved procedure.

30. The computer readable media of claim 16, wherein the instructions, when executed by the processor, cause the processor to perform operations comprising:
accessing a remote master server over a network via a network interface of the cellular device; and
sending a communication to the master server via the network interface, the communication comprising at least one of a request for information that is stored in a memory of the master server or an instruction to update information that is stored in the memory of the master server.
